(19) United States
(12) Patent Application Publication
(10) Pub. No.: US 2006/0037917 A1
(43) Pub. Date: Feb. 23, 2006

(54) Method for washing foodstuff with activated water

(76) Inventor: Kei Usui, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/256,101

(22) Filed: Oct. 24, 2005

Related U.S. Application Data
(63) Continuation of application No. 10/030,420, filed on Jan. 10, 2002, now abandoned.

(30) Foreign Application Priority Data
Jul. 13, 1999 (JP) 11-199604

(51) Int. Cl. C02F 1/70; C02F 1/461

(52) U.S. Cl. 210/757; 205/688; 205/701; 205/742

(57) ABSTRACT

Disclosed is an efficient method for improving the quality and preservability of various kinds of vegetable-origin and animal-origin foodstuffs in a simple method. The method comprises preparing “activated” water by bringing ordinary water into contact with a hydrogen-absorbing alloy such as a palladium-silver alloy loaded with hydrogen and washing the foodstuff with the thus “activated” water.

This is a continuation of U.S. application Ser. No. 10/030,420, filed Jan. 10, 2002, which is a 371 of International Application PCT/JP00/04631, filed Jul. 11, 2000.

### TECHNICAL FIELD

The present invention relates to a method for the improvement of quality of a foodstuff or restoration of the quality of a foodstuff which suffers a loss of freshness or degradation of the taste due to damages on the texture caused, for example, by contacting with certain noxious substances such as chlorine contained in city water in the course of processing including washing with water. In particular, the method comprises washing of the degraded foodstuff with water activated by a specific method which is effective to restore the quality of the foodstuff from damages and to impart the foodstuff with long-term preservability as well as to impart the foodstuff with increased deliciousness resulting in upgrading of the foodstuff quality.

### BACKGROUND ART

It is known that, differently from ordinary water including city water and the water coming directly from a so-called natural water source such as springs and wells, water can be converted into so-called “activated” water having unique properties not found in the raw water per se and capable of exhibiting specific activity to living organisms when the raw water is subjected to an electric or physical treatment such as electrolysis and ultrasonic irradiation and to a chemical treatment with an oxidizing agent or reducing agent as well as to a contacting treatment with a specific mineral.

For example, electrolysis of city water results in the formation of alkalified water and acidified water at the anode side and at the cathode side, respectively, which can be taken out separately. It is generally accepted that the thus alkalified water exhibits activities for freshness preservation of foodstuffs and growth promotion of plants while the acidified water exhibits a microbicidal effect against various kinds of microorganisms.

Although no good understanding has yet been obtained on the mechanism for the “activation” of ordinary water by an electrical, physical or chemical treatment, it is presumable that the mechanism could be explained in terms of partial oxidation and reduction of water molecules, dissociation of associated water molecules, localization of electric charges on the water molecules, existence of free radicals such as active hydrogen and active oxygen, and so on.

One of the methods for the production of such activated water in a large volume utilizable in industrial applications is the electrolysis of water by using a large-capacity electrolytic cell. This electrolytic method, however, is far from industrial practicability in a process where supply of a large volume of activated water is essential as in the production of bean sprouts as a foodstuff because the process of electrolysis per se is operated in a batch process. In addition, the electrolysis voltage in the electrolytic process cannot exceed the decomposition voltage of water giving a limitation to the conditions for imparting negative charges so that the efficiency for the production of activated water is necessarily low with an unduly prolonged treatment time.

It is also known, on the other hand, that foodstuffs in general are subject to damages of the texture by contacting with various kinds of noxious substances in the course of processing or in the course of washing with water resulting in the disadvantages of rottening and degradation of taste.

The present invention has been completed with an object to provide a simple and efficient method for the preparation of “activated” water capable of exhibiting an advantageous physiological effect on the bodies of animals and plants as well as to provide a method for quality upgrading of the quality of various kinds of foodstuffs by restoration from damages on the textures and cells caused in the course of food processing or in the course of washing with water.

### DISCLOSURE OF INVENTION

The inventor has conducted extensive investigations on the method by which various kinds of foods can be imparted with upgraded quality or preservability over a long period of time or by which the taste of the food can be improved arriving at an unexpected discovery that these objects can be accomplished when the food is washed with water which has been activated by contacting with a hydrogen-absorbing alloy as a consequence of restoration from damages in the texture of the foodstuff leading to quality upgrading as an object of the invention.

Thus, the present invention provides a method for quality upgrading of a foodstuff which comprises the step of subjecting the foodstuff to a washing treatment with water activated by being contacted with a hydrogen-absorbing alloy.

### BRIEF DESCRIPTION OF THE DRAWING

FIG. 1 is a schematic axial cross sectional view of an apparatus for the preparation of the activated water used in the inventive method.

FIG. 2 is a schematic axial cross sectional view of another apparatus for the preparation of the activated water used in the inventive method.

### BEST MODE FOR CARRYING OUT THE INVENTION

The hydrogen-absorbing alloy implied here for use in the inventive method includes metals and alloys which are in the form of a hydride combined with the metal or alloy by a physical mechanism such as adsorption and absorption or by a reversible chemical reaction.

While a great variety of hydrogen-absorbing alloys are known heretofore, those having the largest general applicability are the palladium-based alloys containing palladium as the principal ingredient including palladium-niobium alloys, palladium-gold alloys and palladium-silver alloys optionally with further additional alloying metals such as ruthenium, rhodium and the like. Although the simple metal of palladium can occlude about 800 times by volume of hydrogen at room temperature, a serious problem therein is the unavoidable hydrogen embrittlement. This is the reason for the preference of the palladium-based alloys mentioned above to the simple metal of palladium. Although any of the above mentioned palladium-based alloys can be used in the inventive method without particular limitations, palladium-silver alloys are more preferable among them. The weight proportion of palladium and the other alloying metallic elements in the palladium-based hydrogen-absorbing alloy is from 30 to 80% of palladium and from 70 to 20% of the other metals.

While the form of these hydrogen-absorbing alloys for use in the inventive method is not particularly limitative, it is preferable that the alloy is supported on a porous carrier material including porous ceramic carriers and porous plastic carriers. The porous ceramic carrier is exemplified by sintered alumina, sintered silica, sintered silica-alumina, zeolites, “shirasu” pearlite and the like. The porous plastic carrier is exemplified by foamed polystyrenes, foamed polyethylenes, foamed polyurethanes and the like. Various methods can be undertaken for the palladium-based alloy to be supported on the surface of the porous carrier material including the methods of electrolytic plating, electroless plating, chemical vapor deposition, vacuum vapor deposition, sputtering and the like. The film thickness of the palladium-based alloy thus supported on the surface of the porous carrier material is in the range from 1 to 150 μm or, preferably, from 10 to 100 μm.

Since palladium-based alloys are generally soluble in an acid, it is desirable that, when the palladium-based alloy is used according to the inventive method under possible contacting with an acid, the surface of the palladium-based alloy is coated with a layer of an acid-resistant metal, which is preferably gold, in a film thickness of 0.2 to 2 μm. While full prevention can be obtained against the attack of acid to the alloy with the gold plating film of such a small thickness, the rates of hydrogen absorption and desorption to and from the alloy are little affected by the gold plating layer.

Absorption and desorption of hydrogen to and from the palladium-based hydrogen-absorbing alloy can be effected by utilizing the difference in the temperature and/or pressure. Namely, the palladium-based alloy has a capacity to absorb hydrogen under the conditions of low temperatures and high pressures and releases the absorbed hydrogen under the conditions of high temperatures and low pressures. Accordingly, the palladium-based alloy loaded with hydrogen absorbed therein used in the inventive method is obtained by bringing the alloy at a low temperature into contact with pressurized hydrogen gas so as to have the hydrogen gas absorbed in the alloy before the hydrogen-loaded alloy is brought into contact with water at an increased temperature or under a reduced pressure to release hydrogen which activates the water. The water here to be activated need not be free water but can be in the form of an aqueous mixture with an oily substance or with an organic solvent although the advantages by the use of such an aqueous mixture over the use of plain water can be obtained only in limited cases because the conditions for absorption and desorption of hydrogen largely depend on the types of the aqueous mixtures.

Following is a description of a practicing example for the preparation of “activated” water used in the inventive method by making reference to the accompanying drawing.

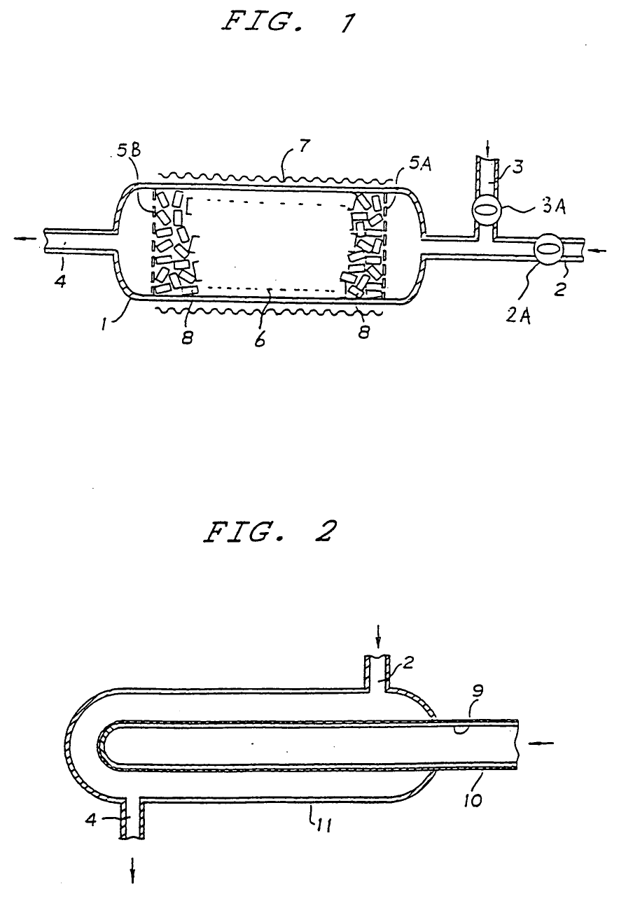

FIG. 1 is a schematic axial cross sectional view of a water-activating reactor suitable for activation of water for use in the inventive method. The reactor consists basically of a cylindrical vessel 1 opening at the right and left end plates and connected there to the water-feed tube 2 having a stopcock 2A and a side branch 3 for hydrogen inlet with a stopcock 3A and to the water-takeout tube 4, respectively. The space in the cylindrical vessel 1 between the perforated plates 5A, 5B is filled with chips 8 of the hydrogen-absorbing alloy to form an alloy-filled bed 6. The cylindrical vessel 1 is surrounded by a temperature-controlling means 7 which can be a coolant- or heating medium-circulating jacket or a heater element assembly. A preferable example of the alloy chips 8 is a tubular ring of sintered porous alumina having an outer diameter of 3 to 50 mm and a length of 5 to 100 mm and supporting a layer of the hydrogen-absorbing palladium-silver alloy having a thickness of about 20 μm formed by vapor deposition and coated with a plating film of gold. The form of the alloy chips 8 is not limited to the above but can be any suitable forms including spheres, plates and rods.

The procedure for the preparation of the “activated” water by using the above described reactor is as follows. In the first place, the reactor vessel 1 holding a packed bed 6 of the alloy chips 8 is chilled from outside by means of the coolant-circulating jacket 7 and, when a desired low temperature of the alloy chips 8 has been reached, hydrogen gas from an appropriate source is introduced through the inlet tube 3 with the stopcock 3A being opened and the stopcock 2A being closed into the reactor vessel 1 through the packed bed 6 of the alloy chips 8 so as to have the hydrogen gas absorbed by the alloy chips 8. When equilibrium has been established between the hydrogen-loaded alloy chips 8 and the flowing hydrogen gas so that absorption of hydrogen gas by the alloy chips 8 can no longer proceed, the flow of the hydrogen gas through the packed bed 6 is switched to a flow of water through the water-feed tube 2 by opening the stopcock 2A and closing the stopcock 3A concurrently with switching of the coolant through the jacket 7 to a heating medium at an elevated temperature so as to effect desorption of the hydrogen gas absorbed by the alloy chips 8. The flowing water is activated by being contacted with the nascent hydrogen as the so-called active hydrogen on the alloy chips 8 and taken out from the water-takeout tube 4 to be used in the inventive method.

Following is a further description of the method for the preparation of activated water by using the apparatus schematically illustrated in FIG. 2 by an axial cross sectional view of the apparatus which basically comprises a jacket tube 11 having a water-feed tube 2 and a water-takeout tube 4 in the vicinities of the right and left end portions, respectively, and surrounding a blind tube 9 made from a gas-permeable porous ceramic material and provided on the outer surface with a coating layer 10 of the hydrogen-absorbing alloy having a thickness of 2 to 100 μm.

The apparatus illustrated in FIG. 2 is run by passing water through the jacket tube 11 from the water-feed tube 2 to the water-takeout tube 4 while the blind tube 9 is filled with pressurized hydrogen gas so that the hydrogen gas permeates the porous ceramic wall of the blind tube 9 to be absorbed by the layer 10 of the hydrogen-absorbing alloy and then released at the outer surface of the alloy layer 9 under normal pressure to activate the water in contact therewith.

In practicing the inventive method for the treatment of a foodstuff with the activated water, the above described water-activating reactor is installed at an appropriate site from which a necessary volume of the activated water is supplied as the washing water for foods by passing raw water through the reactor at an appropriate flow rate. The optimum time length for washing foods with the activated water depends on the kind of the foodstuffs. When the food is a meat or fish, for example, the washing time should be as short as possible in the range of 1 to 5 seconds in order to avoid any damages on the tissues of the meat or fish. The washing time for vegetables and cereals can be extended to 1 to 10 minutes by which restoration of damaged texture can be expected. The washings after the washing treatment of foods can be discharged as such without particular problems relative to environmental pollution though dependent on the nature of the foods washed with the activated water. In some cases, the washings can be returned to the reactor for water activation to be suitable for reuse.

In the following, the method of the present invention is described in more detail by way of Examples for a variety of foodstuffs as preceded by a Reference Example describing preparation of activated water. Reference Example.

The water-activating reactor used in the Examples basically had a structure illustrated in FIG. 2. Thus, a reactor tube was constructed from a stainless steel jacket tube 11 having an inner diameter of 0.3 meter and a length of 4 meters which surrounded a plurality of blind tubes 9 of a sintered porous alumina ceramic each having an outer diameter of 20 mm and a length of 3.6 meters and provided on the outer surface with a coating layer 10 of a palladium-silver alloy of 10 μm thickness and a 1 μm thick plating film of gold thereon. Hydrogen gas was introduced under pressurization to 8.8×10⁵ Pa into the porous alumina tubes 9 at a rate of 1 liter per minute at 15° C. while water taken from a well was passed through the jacket tube 11 at a flow rate of 1000 liters per minute to be taken out as activated water.

### EXAMPLE 1

A 355 g portion of Japonica-type rice after 3 times washing with the activated water was soaked for 30 minutes in 400 ml of the activated water and then cooked in an electric rice cooker to prepare cooked rice, referred to as the inventive cooked rice hereinafter.

Separately for comparison, the same rice cooking procedure was undertaken as above excepting for the replacement of the activated water with ordinary city water to prepare the comparative cooked rice.

The cooking yields for the inventive cooked rice and comparative cooked rice were 2.152 and 2.135, respectively. Some improvements could be noted in the appearance, i.e. color tone and glossiness, of the inventive cooked rice just cooked as compared with the comparative cooked rice.

After keeping for 24 hours and 48 hours at 25° C., microbial counting tests were undertaken for these cooked rice samples for overall viable number of bacteria and number of colon bacilli to find that, while absolutely no colon bacilli could be detected in each of the samples even after keeping for 48 hours, the overall viable number of bacteria, which was zero in each of the samples just as cooked, was as shown in Table 1 below.

TABLE 1

| Cooked | Overall viable bacteria | | |
|---|---|---|---|
| rice | as cooked | after 24 hours | after 48 hours |
| Inventive | 0 | 3.5 × 10³ | 7.8 × 10⁵ |
| Comparative | 0 | 6.3 × 10⁴ | 5.2 × 10⁷ |

As is understood from this table, the viable number of bacteria could be substantially decreased after keeping for 24 hours and 48 hours in the inventive cooked rice as compared with the comparative cooked rice to maintain freshness of the food over a substantially extended time. The mechanism therefor is presumable that the activated water has an activity to suppress hydrolysis of rice starch resulting in a decreased production of monosaccharides which can be a factor for promoting growth of bacteria.

### EXAMPLE 2

Chopped pieces of Japanese radish in an amount of 100 kg a lot were immersed for 10 minutes in city water (comparative) or in the activated water (inventive) followed by centrifugal dehydration at 800 rpm for 60 seconds and weight measurement of the dehydrated radish chops to calculate the yield. This test was undertaken for 10 lots with city water and for 10 lots with the activated water. The results are shown in Table 2.

TABLE 2

Yields, %

| Lot No. | Comparative | Inventive |
|---|---|---|
| 1 | 92.1 | 98.8 |
| 2 | 93.3 | 96.2 |
| 3 | 93.1 | 97.8 |
| 4 | 92.4 | 97.2 |
| 5 | 94.4 | 96.3 |
| 6 | 95.1 | 98.8 |
| 7 | 91.8 | 97.5 |
| 8 | 93.3 | 96.3 |
| 9 | 92.5 | 98.4 |
| 10 | 92.8 | 96.5 |
| Average | 93.1 | 97.4 |

This table indicates that an improvement of 4.3% can be obtained in the yield of radish chops by using the activated water as compared with the city water.

### EXAMPLE 3

Preservation tests of chopped vegetable pieces were undertaken for onions, cucumbers and lettuces after washing with city water (comparative) or with the activated water (inventive) and microbial inspection was undertaken to count the overall viable number of bacteria and number of colon bacilli. The storage temperature was 2° C. for the first 24 hours, 8° C. for the second 24 hours and 10° C. for the third 24 hours. The results are shown in Table 3.

TABLE 3

| | | Comparative | | Inventive | |
|---|---|---|---|---|---|
| Chopped | | Overall | | Overall | |
| vegetable | Preservation, | viable | Coliform | viable | Coliform |
| pieces | hours | bacteria | bacteria | bacteria | bacteria |
| Onion | as | 4.4 × 10³ | 1.4 × 10³ | 1.2 × 10⁴ | <10 |
| | washed | | | | |
| | 24 | 4.7 × 10² | 5.8 × 10² | 1.8 × 10³ | 3.9 × 10 |
| | 48 | 2.5 × 10³ | 5.7 × 10² | 7.1 × 10 | <10 |
| | 72 | 1.9 × 10⁴ | 6.3 × 10³ | 3.1 × 10² | <10 |
| Cucumber | as | 1.7 × 10³ | 6.0 × 10 | 6.4 × 10³ | 10 |
| | washed | | | | |
| | 24 | 3.7 × 10² | 1.0 × 10² | 8.0 × 10³ | <10 |
| | 48 | 5.0 × 10² | 2.6 × 10² | 7.2 × 10³ | <10 |
| | 72 | 1.1 × 10⁴ | 6.3 × 10³ | 6.0 × 10³ | <10 |
| Lettuce | as | 1.7 × 10⁴ | 9.0 × 10 | 2.3 × 10³ | 10 |
| | washed | | | | |
| | 24 | 6.2 × 10³ | <10 | 3.4 × 10² | <10 |
| | 48 | 2.2 × 10³ | 1.3 × 10² | 1.1 × 10³ | 2.0 × 10² |
| | 72 | 2.3 × 10³ | 6.9 × 10² | 3.0 × 10³ | 5.0 × 10 |

The results relative to growth suppression of coliform bacteria by the activated water suggest that the activated water has activity to reduce production of monosaccharides which may be produced when vegetable tissues are destroyed or damaged.

### EXAMPLE 4

Preservation test of rib beefs was undertaken at 4° C. after washing with city water (comparative) or with the activated water (inventive) over a period of 15 days with periodical counting of the overall viable number of bacteria per gram of the meat to give the results shown in Table 4.

TABLE 4

| | |
|---|---|
| | Overall viable number of |
| Preservation, | bacteria per gram |

| days | Comparative | Inventive |
|---|---|---|
| 0 | 7.1 × 10⁴ | 7.4 × 10³ |
| 3 | 8.2 × 10⁴ | 1.4 × 10³ |
| 6 | 1.3 × 10⁵ | 9.3 × 10² |
| 8 | 1.4 × 10⁶ | 1.9 × 10⁴ |
| 10 | 4.5 × 10⁶ | 4.3 × 10⁴ |
| 13 | 7.6 × 10⁷ | 1.2 × 10⁴ |
| 15 | 1.1 × 10⁸ | 1.8 × 10⁵ |

As is indicated in Table 4, a substantial improvement can be obtained in the preservability of meat by washing with the activated water.

### EXAMPLE 5

A preservation test of whole cabbages at 10° C. was undertaken after washing with city water (comparative) or with the activated water (inventive) to give the results shown in Tables 5A and 5B for the microbial tests and the organoleptic and visual tests, respectively.

Thus, inspection of the cabbages was undertaken periodically during the storage period over 8 days for the items including, in addition to the numbers of bacteria, unpleasant smell, juice dripping, appearance of brownish leaves and appearance of blackened leaves. The results in each of these organoleptic and visual items were recorded in three ratings of A, B and C according to the criteria the same condition as just washed; B for a condition with a slight degradation but retaining the commercial value; and C for a condition not suitable for use as a food.

TABLE 5A

| | Inventive | | Comparative | |
|---|---|---|---|---|
| | Overall | | Overall | |
| Preservation, | viable | Coliform | viable | Coliform |
| days | bacteria | bacteria | bacteria | Bacteria |
| Before | 1.9 × 10⁶ | 3.1 × 10⁴ | 1.9 × 10⁶ | 3.1 × 10⁴ |
| washing | | | | |
| As | 0 | 0 | 1.8 × 10² | 0 |
| washed | | | | |
| 1 | 6.1 × 10 | 0 | 2.1 × 10⁴ | 6.0 × 10² |
| 2 | 2.3 × 10² | 0 | 1.2 × 10⁵ | 9.9 × 10³ |
| 3 | 2.5 × 10² | 1.1 × 10 | 2.5 × 10⁵ | 1.2 × 10⁴ |
| 4 | 1.3 × 10³ | 2.7 × 10² | 1.8 × 10⁶ | 3.5 × 10⁵ |
| 5 | 2.7 × 10⁴ | 4.2 × 10³ | 5.9 × 10⁷ | 5.5 × 10⁶ |
| 6 | 1.6 × 10⁵ | 8.5 × 10⁴ | 2.4 × 10⁸ | 7.1 × 10⁷ |
| 8 | 2.7 × 10⁶ | 9.8 × 10⁵ | 7.6 × 10¹⁰ | 8.9 × 10⁹ |

TABLE 5B

| Pres- | Inventive | | | | Comparative | | | |
|---|---|---|---|---|---|---|---|---|
| erva- | | | | Black- | | | | Black- |
| tion, | | Drip- | Brown | ened | | Drip- | Brown | ened |
| days | Smell | Ping | Leaves | leaves | Smell | ping | Leaves | leaves |
| 1 | A | A | A | A | A | A | A | A |
| 2 | A | A | A | A | A | A | A | A |
| 3 | A | A | A | A | A | A | A | Partial- |
| | | | | | | | | ly B |
| 4 | A | A | A | A | A | B | B | B |
| 5 | A | A | A | Partial- | A | B | C | C |
| | | | | ly B | | | | |
| 6 | A | A | A | Partial- | A | B | C | C |
| | | | | ly B | | | | |
| 8 | B | B | C | C | B | B | C | C |

As is shown in these tables, substantial improvements can be obtained not only in the microbial tests but also in the organoleptic and visual tests by washing with the activated water.

### EXAMPLE 6

“Mozuku”, an edible seaweed of the family Spermatochnaceae, in an amount of 1.5 kg was treated in the following manner with the activated water (inventive) or with city water (comparative). Thus, the seaweed was taken in a glass bowl of 4 liter capacity which was filled with the water and the ramified seaweed was thoroughly disintegrated by hand in the water. The seaweed was taken in a draining basket and the water was thoroughly drained from the seaweed. After twice repeating this procedure, the seaweed was freed from free water as completely as possible on a draining basket.

A 125 g portion taken from the thus treated seaweed and diluted three times with addition of water was taken in a container with covering and stored in a refrigerator at 5° C. After 2 days of storage, the seaweed was taken out of the container and tested for the visual appearance, tastiness and chew feeling to find that, although no differences were noted in the visual appearance and chew feeling between the samples after washing with the activated water and with the city water, a clear difference could be noted in the tastiness therebetween, the seaweed after washing with the activated water being superior to that after washing with the city water.

Thereafter, the container was again covered and kept in the refrigerator for additional 24 hours and the seaweed samples taken out of the container were subjected to the same organoleptic tests as above to find that, while no noticeable changes were found in the seaweed after treatment with the activated water as compared with the results in the tests after 2 days storage, denaturation had clearly proceeded in the visual appearance of the seaweed after treatment showing mushy appearance.

The results of the further organoleptic tests undertaken after two more days of storage in the refrigerator were about the same as those in the above mentioned second evaluation tests excepting for further proceeding of degradation in the tastiness and chew feeling of the seaweed after treatment with the city water.

### EXAMPLE 7

A 500 g portion of fresh “ikra”, i.e. disintegrated salmon eggs, as just landed was taken in a draining basket and the basket was put into a washing machine to have the “ikra” washed for 1 minute in a stream of running water with the activated water (inventive) or with city water (comparative).

The thus washed salmon eggs were dipped and kept overnight in a seasoning sauce prepared by using the activated water or the same city water, respectively, at 10° C. followed by measurement of the thus seasoned salmon eggs. The results are shown in Table 6.

Further, the same sample of the seasoned salmon eggs was freeze-stored at −30° C. followed by thawing and second measurement of the weight of the thus thawed salmon eggs. The results are shown also in Table 6.

TABLE 6

| | |
|---|---|
| As seasoned | As thawed |

| | weight, g | yield, % | weight, g | yield, % |
|---|---|---|---|---|
| Inventive | 582 | 116.4 | 436 | 87.2 |
| Comparative | 562 | 112.4 | 428 | 85.6 |

As is indicated in Table 6, substantial improvements can be obtained in the yield of the seasoned salmon eggs by the treatment with the activated water as a result of a decrease in the dripping from the eggs which also means an improvement in the quality thereof as a food product.

### INDUSTRIAL APPLICABILITY

The inventive method provides a means for greatly improving the quality of various foodstuffs by washing the foodstuff with activated water obtained in a simple method.

1. A method for improving the quality of a foodstuff which comprises the step of subjecting the foodstuff to a washing treatment with activated water prepared by contacting water with an alloy having absorbed hydrogen which is produced by contacting an alloy with hydrogen gas, whereby said alloy bearing absorbed hydrogen releases hydrogen on contact with said water to activate said water.

2. The method for improving the quality of a foodstuff as claimed in claim 1 in which the hydrogen-absorbing alloy is a palladium-based alloy.

3. The method according to claim 1, wherein said water contacts said alloy bearing absorbed hydrogen under elevated temperature or reduced pressure to release said hydrogen.
